(19) United States
(12) Patent Application Publication
(10) Pub. No.: US 2025/0260198 A1
(43) Pub. Date: Aug. 14, 2025

(54) ELECTRICAL DEVICE AND CONNECTING STRUCTURE THEREOF

(71) Applicant: Sungrow (Shanghai) Co., Ltd., Shanghai (CN)

(72) Inventors: Feng Li, Shanghai (CN); Shiyuan Wei, Shanghai (CN); Yu Yang, Shanghai (CN)

(73) Assignee: Sungrow (Shanghai) Co., Ltd., Shanghai (CN)

(21) Appl. No.: 19/103,443

(22) PCT Filed: May 30, 2023
(86) PCT No.: PCT/CN2023/097042

§ 371 Date: Feb. 12, 2025

(30) Foreign Application Priority Data
Sep. 15, 2022 (CN) 202222448371.9

(51) Int. Cl. H01R 13/64

(52) U.S. Cl. CPC H01R 13/64

(57) ABSTRACT

A connecting structure of an electrical device includes an input positive terminal, an output positive terminal, an input negative terminal, and an output negative terminal. Each of the input positive terminal, the output positive terminal, the input negative terminal and the output negative terminal includes a plugging part. Specifically, the plugging parts of the input positive terminal and the output positive terminal are different, so that the situation that a worker wrongly connects the input positive terminal and the output positive terminal is avoided; and/or, the plugging parts of the input negative terminal and the output negative terminal are different, so that the situation that a worker wrongly connects the input negative terminal and the output negative terminal is avoided.

This application claims the priority to Chinese Patent Application No. 202222448371.9, titled “ELECTRICAL DEVICE AND CONNECTING STRUCTURE THEREOF”, filed with the China National Intellectual Property Administration on Sep. 15, 2022, the entire disclosure of which is incorporated herein by reference.

### FIELD

The present application relates to the technical field of wiring of electrical devices, and in particular to an electrical device and a connecting structure thereof.

### BACKGROUND

At present, electrical devices are connected via terminals at direct-current sides. Specifically, the electrical device has input terminals and output terminals. The input terminals include a positive input terminal and a negative input terminal, and the output terminals include a positive output terminal and a negative output terminal. Since the input terminals and the output terminals are both universal terminals, a worker is apt to confuse the input terminals with the output terminals for connection. For example, a positive input terminal might be mistakenly taken as a positive output terminal for connection with a corresponding device, or a negative output terminal might be mistakenly taken as a negative input terminal for connection with a corresponding device, causing the electrical device to fail to operate normally and leading to safety hazards. Furthermore, if the input terminals and the output terminals are mistakenly connected, the product has to be returned to the factory, resulting in a huge waste of money and time.

In summary, a problem to be solved by those skilled in the art is how to avoid mistaken connection of the input terminals and the output terminals by the worker.

### SUMMARY

In view of this, an object of the present application is to provide a connecting structure of an electrical device, to avoid mistaken connection of an input terminal and an output terminal by a worker. Another object of the present application is to provide an electrical device that includes the above connecting structure.

To achieve the above objects, the following technical solutions are provided according to the present application.

A connecting structure of an electrical device includes a positive input terminal, a positive output terminal, a negative input terminal, and a negative output terminal, where
the positive input terminal, the positive output terminal, the negative input terminal, and the negative output terminal each includes a plug connection portion; and
the plug connection portion of the positive input terminal is different from the plug connection portion of the positive output terminal, and/or, the plug connection portion of the negative input terminal is different from the plug connection portion of the negative output terminal.

Optionally, the plug connection portion of the positive input terminal is different from the plug connection portion of the negative input terminal, and/or, the plug connection portion of the positive output terminal is different from the plug connection portion of the negative output terminal.

Optionally, the difference between the plug connection portions includes a difference in shapes between the plug connection portions and/or a difference in sizes between the plug connection portions.

Optionally, the positive input terminal, the positive output terminal, the negative input terminal, and the negative output terminal each includes a connecting portion configured to connect a wire with the plug connection portion; where
the connecting portion of the positive input terminal is different from the connecting portion of the positive output terminal, and/or, the connecting portion of the negative input terminal is different from the connecting portion of the negative output terminal.

Optionally, the connecting portion of the positive input terminal is different from the connecting portion of the negative input terminal, and/or, the connecting portion of the positive output terminal is different from the connecting portion of the negative output terminal.

Optionally, the difference between the connecting portions includes a difference in shapes between the connecting portions and/or a difference in sizes between the connecting portions.

Optionally, the connecting structure of the electrical device further includes:
a positive input wire configured to connect a housing of the electrical device with the positive input terminal,
a positive output wire configured to connect the housing with the positive output terminal,
a negative input wire configured to connect the housing with the negative input terminal, and
a negative output wire configured to connect the housing with the negative output terminal, where
the positive input wire is different from the positive output wire, and/or, the negative input wire is different from the negative output wire.

Optionally, the positive input wire is different from the negative input wire, and/or, the positive output wire is different from the negative output wire.

Optionally, the positive input wire, the positive output wire, the negative input wire, and the negative output wire are wires, and the difference between the wires includes a difference in lengths between the wires, and/or a difference in colors between the wires, and/or a difference in outer diameters between the wires.

Optionally, the negative input terminal and the negative output terminal are both female plugs, and the positive input terminal and the positive output terminal are both male plugs.

Optionally, the number of the positive input terminal and the number of the negative input terminal are both one.

Optionally, the number of the positive input terminal and the number of the negative input terminal are both at least two, and the positive input terminals are in one-to-one correspondence with the negative input terminals.

Optionally, the plug connection portions of any two of the positive input terminals are the same, and/or, the plug connection portions of any two of the negative input terminals are the same.

Optionally, the positive output terminal of the electrical device is configured to be connected to a negative output terminal of another electrical device by insertion.

Based on the above connecting structure of the electrical device, an electrical device is further provided according to the present application, including the connecting structure of the electrical device according to any one of the above solutions.

According to the connecting structure of the electrical device provided in the present application, since the plug connection portions of the positive input terminal and the positive output terminal are different, the insertion cannot be achieved if the worker mistakenly use the positive input terminal as the positive output terminal, or use the positive output terminal as the positive input terminal, which avoids mistaken connection of the positive input terminal and the positive output terminal by the worker. And/or, since the plug connection portions of the negative input terminal and the negative output terminal are different, the insertion cannot be achieved if the worker mistakenly use the negative input terminal as the negative output terminal, or use the negative output terminal as the negative input terminal, which avoids mistaken connection of the negative input terminal and the negative output terminal by the worker. Thus, with the above connecting structure of the electrical device, mistaken connection of the input terminals and the output terminals by the worker can be avoided.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only some examples of the present application, and for those skilled in the art, other drawings may be obtained based on these drawings without any creative efforts.

FIG. 1 is a schematic view showing the structure of a connecting structure of an electrical device according to an embodiment of the present application;

FIG. 2 is a front view of the connecting structure of the electrical device according to the embodiment of the present application;

FIG. 3 is a schematic view showing the structure of a negative output terminal of the connecting structure of the electrical device according to an embodiment of the present application;

FIG. 4 is a schematic view showing the structure of a first negative input terminal of the connecting structure of the electrical device according to an embodiment of the present application;

FIG. 5 is a schematic view showing the structure of a first positive input terminal of the connecting structure of the electrical device according to an embodiment of the present application;

FIG. 6 is a schematic view showing the structure of a positive output terminal of the connecting structure of the electrical device according to an embodiment of the present application;

FIG. 7 is a schematic view showing the structure of a second positive input terminal of the connecting structure of the electrical device according to an embodiment of the present application;

FIG. 8 is a schematic view showing the structure of a second negative input terminal of the connecting structure of the electrical device according to an embodiment of the present application;

FIG. 9 is a schematic view showing the connection between two electrical devices according to an embodiment of the present application; and

FIG. 10 is a partially enlarged view of FIG. 9.

Reference numerals:

| | | | |
|---|---|---|---|
| 11 | negative output terminal, | 12 | negative input terminal, |
| 13 | positive input terminal, | 14 | positive output terminal, |
| 12a | first negative input | 12b | second negative input |
| | terminal, | | terminal, |
| 13a | first positive input | 13b | second positive input |
| | terminal, | | terminal, |
| 21 | negative output wire, | 22 | negative input wire, |
| 23 | positive input wire, | 24 | positive output wire, |
| 22a | first negative input wire, | 22b | second negative input wire, |
| 23a | first positive input | 23b | second positive input |
| | terminal, | | terminal, |
| 31 | housing, | 01 | plug connection portion, |
| 02 | connecting portion. | | |

### DETAILED DESCRIPTION OF THE EMBODIMENTS

Technical solutions according to the embodiments of the present application will be described clearly and completely as follows in conjunction with the accompany drawings in the embodiments of the present application. It is obvious that the described embodiments are only a part of the embodiments according to the present application, rather than all of the embodiments. All the other embodiments obtained by those skilled in the art based on the embodiments in the present application without any creative work belong to the scope of protection of the present application.

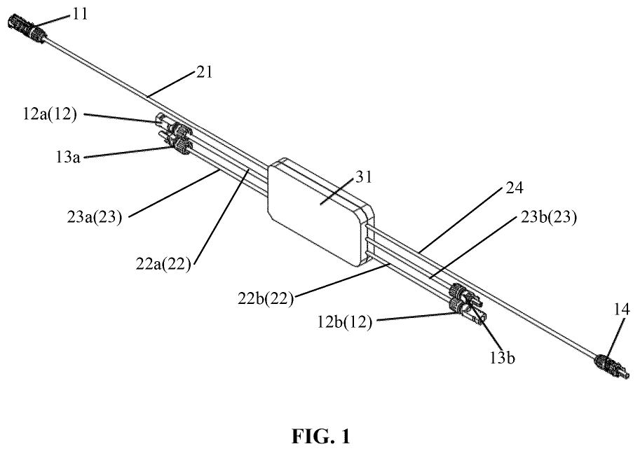

As shown in FIGS. 1 and 2, a connecting structure of an electrical device according to an embodiment of the present application includes a positive input terminal 13, a positive output terminal 14, a negative input terminal 12, and a negative output terminal 11.

Specifically, the negative input terminal 12 and the positive input terminal 13 are both connected to a junction box or other devices, and the positive output terminal 14 and the negative output terminal 11 are both connected to a junction box or other devices.

The positive input terminal 13, the positive output terminal 14, the negative input terminal 12, and the negative output terminal 11 each includes a plug connection portion 01. Specifically, the plug connection portion 01 of the positive input terminal 13 is different from the plug connection portion 01 of the positive output terminal 14; and/or, the plug connection portion 01 of the negative input terminal 12 is different from the plug connection portion 01 of the negative output terminal 11.

According to the above connecting structure of the electrical device, since the plug connection portions 01 of the positive input terminal 13 and the positive output terminal 14 are different, the insertion cannot be achieved if a worker mistakenly use the positive input terminal 13 as the positive output terminal 14, or use the positive output terminal 14 as the positive input terminal 13, realizing a fool-proofing effect, thereby avoiding mistaken connection of the positive input terminal 13 and the positive output terminal 14 by the worker. Since the plug connection portions 01 of the negative input terminal 12 and the negative output terminal 11 are different, the insertion cannot be achieved if the worker mistakenly use the negative input terminal 12 as the negative output terminal 11, or use the negative output terminal 11 as the negative input terminal 12, realizing a fool-proofing effect, thereby avoiding mistaken connection of the negative input terminal 12 and the negative output terminal 11. Thus, with the above connecting structure of the electrical device, mistaken connection of the input terminals and the output terminals by the worker can be avoided.

In a specific example, the plug connection portion 01 of the positive input terminal 13 is different from the plug connection portion 01 of the negative input terminal 12. As such, mistaken connection of the positive input terminal 13 and the negative input terminal 12 by the worker can be avoided.

Correspondingly, the plug connection portion 01 of the positive output terminal 14 is different from the plug connection portion 01 of the negative output terminal 11. As such, mistaken connection of the positive output terminal 14 and the negative output terminal 11 by the worker can be avoided.

The above differences between the plug connection portions 01 can be realized in many ways. Specifically, the above differences between the plug connection portions 01 include a difference in shapes between the plug connection portions 01 and/or a difference in sizes between the plug connection portions 01. Certainly, the plug connection portions 01 may be different from each other in colors, which is not limited in the present embodiment.

In the above connecting structure of the electrical device, each of the positive input terminal 13, the positive output terminal 14, the negative input terminal 12, and the negative output terminal 11 further includes a connecting portion 02 configured for connecting a wire with the plug connection portion 01.

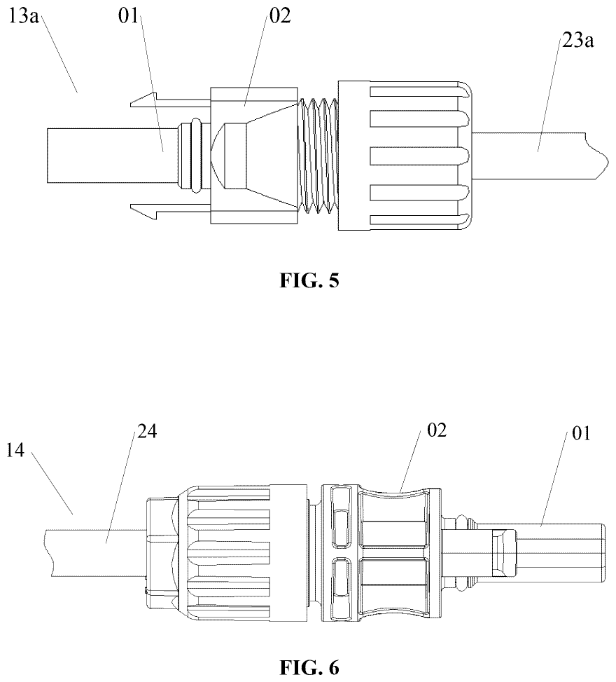

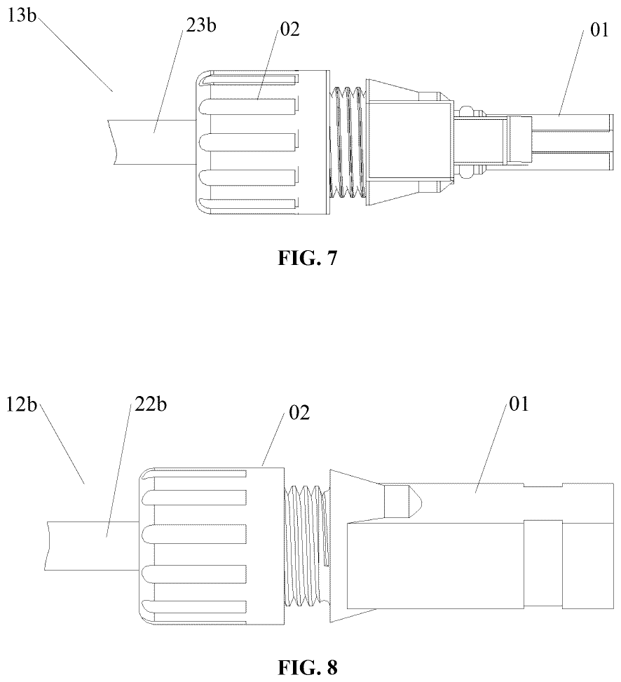

As shown in FIGS. 2, 5, 6 and 7, the connecting portion 02 of the positive input terminal 13 may be different from the connecting portion 02 of the positive output terminal 14, to avoid mistaken connections of the positive input terminal 13 and the positive output terminal 14.

Correspondingly, as shown in FIGS. 2, 3, 4 and 8, the connecting portion 02 of the negative input terminal 12 may be different from the connecting portion 02 of the negative output terminal 11, to avoid mistaken connections of the negative input terminal 12 and the negative output terminal 11.

Correspondingly, as shown in FIGS. 2, 4, 5, 7 and 8, the connecting portion 02 of the positive input terminal 13 may be different from the connecting portion 02 of the negative input terminal 12, to avoid mistaken connections of the positive input terminal 13 and the negative input terminal 12.

Correspondingly, as shown in FIGS. 2, 3 and 6, the connecting portion 02 of the positive output terminal 14 may be different from the connecting portion 02 of the negative output terminal 11, to avoid mistaken connections of the positive output terminal 14 and the negative output terminal 11.

The above differences between the connecting portions 02 can be realized in many ways. Specifically, the above differences between the connecting portions 02 include a difference in shapes between the connecting portions 02 and/or a difference in sizes between the connecting portions 02. Certainly, the connecting portions 02 may be different from each other in colors, which is not limited in the present embodiment.

In a specific example, the above connecting structure of the electrical device further includes a positive input wire 23, a positive output wire 24, a negative input wire 22, and a negative output wire 21. The positive input wire 23 is configured to connect a housing 31 of the electrical device with the positive input terminal 13, and the positive output wire 24 is configured to connect the housing 31 with the positive output terminal 14. The negative input wire 22 is configured to connect the housing 31 with the negative input terminal 12, and the negative output wire 21 is configured to connect the housing 31 with the negative output terminal 11.

Each of the positive input wire 23, the positive output wire 24, the negative input wire 22 and the negative output wire 21 is generally referred to as the wire mentioned above.

In the present embodiment, the positive input wire 23 is different from the positive output wire 24, to avoid mistaken connections of the positive input terminal 13 and the positive output terminal 14. Correspondingly, the negative input wire 22 may be different from the negative output wire 21, to avoid mistaken connections of the negative input terminal 12 and the negative output terminal 11.

Correspondingly, the positive input wire 23 may be different from the negative input wire 22, to avoid mistaken connections of the positive input terminal 13 and the negative input terminal 12.

Correspondingly, the positive output wire 24 may be different from the negative output wire 21 to avoid mistaken connections of the positive output terminal 14 and the negative output terminal 11.

As described hereinabove, the positive input wire 23, the positive output wire 24, the negative input wire 22, and the negative output wire 21 are wires. The differences between the wires include a difference in lengths between the wires, and/or a difference in colors between the wires, and/or a difference in outer diameters between the wires. Certainly, the wires may be different from each other in shapes, i.e., the wires have different cross-sectional shapes.

As shown in FIG. 2, a length of the positive input wire 23 is smaller than a length of the positive output wire 24, and a length of the negative input wire 22 is smaller than a length of the negative output wire 21.

In other examples, as shown in FIG. 2, the length of the positive input wire 23 is equal to the length the negative input wire 22, and the length of the positive output wire 24 is equal to the length of the negative output wire 21, which are not limited to the above examples.

The plug connection portion 01 may be a jack or a pin. If the plug connection portion 01 is a jack, then the terminal having this plug connection portion 01 is a female plug. If the plug connection portion 01 is a pin, then the terminal having this plug connection portion 01 is a male plug.

The specific types of the positive input terminal 13, the positive output terminal 14, the negative input terminal 12, and the negative output terminal 11 may be determined according to practice. Specifically, the negative input terminal 12 and the negative output terminal 11 are both female plugs, and the positive input terminal 13 and the positive output terminal 14 are both male plugs. Alternatively, the negative input terminal 12 and the negative output terminal 11 are both male plugs, and the positive input terminal 13 and the positive output terminal 14 are both female plugs, which are not limited to the above example.

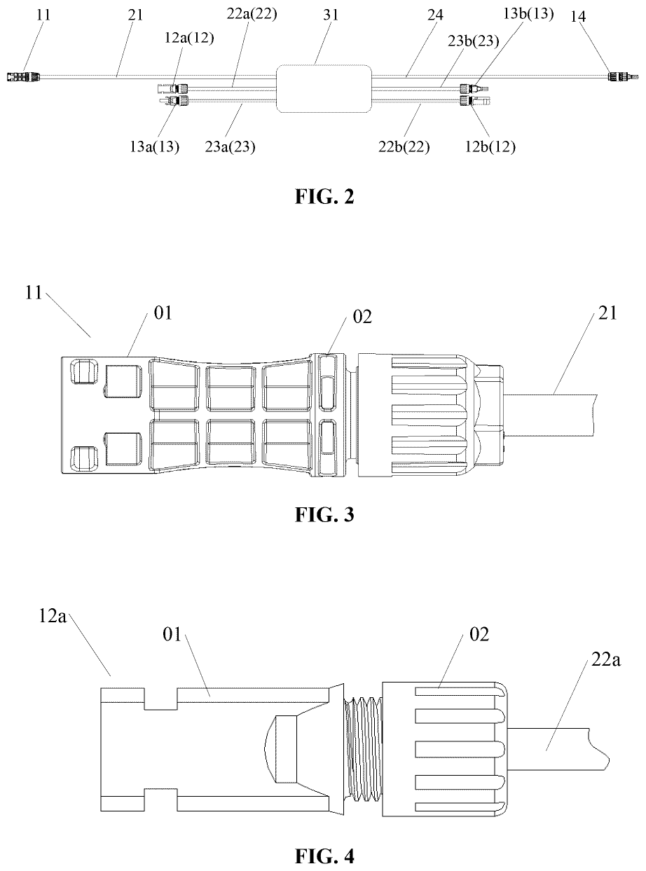

As shown in FIGS. 2 and 3, the plug connection portion 01 of the negative output terminal 11 is a jack. As shown in FIGS. 2, 4 and 8, the plug connection portion 01 of the negative input terminal 12 is also a jack. A shape of the plug connection portion 01 of the negative output terminal 11 is different from a shape of the plug connection portion 01 of the negative input terminal 12, that is, an outer surface of the jack of the negative output terminal 11 and an outer surface of the jack of the negative input terminal 12 are different in shape.

As shown in FIGS. 2, 5 and 7, the plug connection portion 01 of the positive input terminal 13 is a pin. As shown in FIGS. 2 and 6, the plug connection portion 01 of the positive output terminal 14 is also a pin. A shape of the plug connection portion 01 of the positive input terminal 13 is different from a shape of the plug connection portion 01 of the positive output terminal 14, that is, the pin of the positive input terminal 13 and the pin of the positive output terminal 14 are different in shape.

In the connecting structure of the electrical device, the number of the positive input terminal 13 and the number of the negative input terminal 12 may both be one, or may both be at least two.

It should be noted that, in a case that the number of the positive input terminal 13 and the number of the negative input terminal 12 are both at least two, the positive input terminals 13 are in one-to-one correspondence with the negative input terminals 12. In a case that the number the positive input terminal 13 and the number of the negative input terminal 12 are both at least two, and the number of the positive input wire 23 and the number of the negative input wire 22 are both at least two, the positive input terminals 13 are in one-to-one correspondence with the positive input wires 23, and the negative input terminals 12 are in one-to-one correspondence with the negative input wires 22. Each of the positive input terminals 13 is different from the positive output terminal 14, and each of the negative input terminals 12 is different from the negative output terminal 11.

In a case that the number of the positive input terminal 13 and the number of the negative input terminal 12 are both at least two, the plug connection portions 01 of any two of the positive input terminals 13 may be the same, and the plug connection portions 01 of any two of the at least two negative input terminals 12 may be the same. Alternatively, as shown in FIG. 2, the plug connection portions 01 of any two of the positive input terminals 13 are different, and the plug connection portions 01 of any two of the negative input terminals 12 are different.

Correspondingly, the connecting portions 02 of any two of the positive input terminals 13 may be the same, and the connecting portions 02 of any two of the negative input terminals 12 may be the same. Alternatively, as shown in FIG. 2, the connecting portions 02 of any two of the positive input terminals 13 are different, and the connecting portions 02 of any two of the negative input terminals 12 are different.

Correspondingly, as shown in FIG. 2, any two of the positive input wires 23 are the same, and any two of the negative input wires 22 are the same. Alternatively, any two of the positive input wires 23 may be different, and any two of the negative input wires 22 may be different.

The specific number of each of the positive input terminal 13 and the negative input terminal 12 may be determined according to practice, and is not limited in the present embodiment.

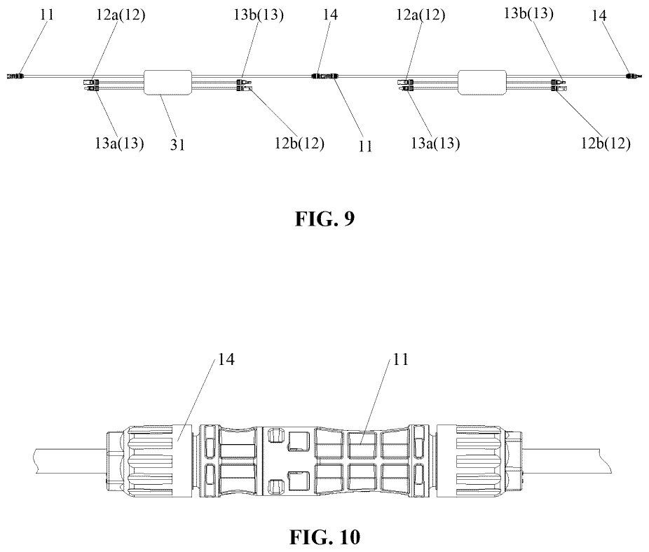

In the above connecting structure of the electrical device, the number of the positive output terminal 14 and the number of the negative output terminal 11 may both be one. To connect two electrical devices in series, as shown in FIGS. 9 and 10, the positive output terminal 14 of one of the two electrical devices can be connected to the negative output terminal 11 of the other one of the two electrical devices in an insertion manner, which may also be understood as that, the negative output terminal 11 of one of the two electrical devices can be connected to the positive output terminal 14 of the other one of the two electrical devices in an insertion manner. It may be appreciated that, at least two electrical devices can be connected in series. The number of the electrical devices connected in series is determined according to practice, which is not limited in the present embodiment.

Specifically, one of the positive output terminal 14 and the negative output terminal 11 is a male plug, and the other one is a female plug matching the male plug.

Based on the connecting structure of the electrical device according to the above embodiments, an electrical device is further provided in the present embodiment, including the connecting structure of the electrical device according to the above embodiments.

To facilitate description, the negative output terminal 11, the negative input terminal 12, the positive input terminal 13, and the positive output terminal 14 are all referred to as terminals. The electrical device includes a housing 31, and the terminals are arranged on the housing 31. Specifically, the housing 31 has a front face, a rear face and side faces connecting the front face with the rear faces. At least one of the terminals is connected to a side face of the housing 31, and/or at least one of the terminals is connected to the front face of the housing 31, and/or at least one of the terminals is connected to the rear face of the housing 31.

As shown in FIG. 1, the negative output terminal 11, the negative input terminal 12, the positive input terminal 13, and the positive output terminal 14 are all arranged on the side faces of the housing 31. The number of the side faces of the housing 31 is four. The number of the negative input terminal 12 is two, namely a first negative input terminal 12a and a second negative input terminal 12b. The number of the positive input terminal 13 is two, namely a first positive input terminal 13a and a second positive input terminal 13b. The negative output terminal 11, the first negative input terminal 12a and the first positive input terminal 13a are all located at one of the side faces of the housing 31, and the positive output terminal 14, the second negative input terminal 12b and the second positive input terminal 13b are all located at another one of the side faces of the housing 31.

In other examples, the negative output terminal 11 and the positive output terminal 14 may be located at different side faces, the first negative input terminal 12a and the second negative input terminal 12b may be located at the same side face, and the first positive input terminal 13a and the second positive input terminal 13b may be located at the same side face, which are not limited in this embodiment.

The housing 31 may be a metal housing, a plastic housing or the like, which is not limited in this embodiment.

Since the connecting structure of the electrical device according to the above embodiments has the above technical effects, and the above electrical device includes the above connecting structure of the electrical device, the above electrical device also has the corresponding technical effects, which are not described in detail herein.

The type of the electrical device can be chosen according to practice. For example, the electrical device may be a circuit breaker, which is not limited in the present embodiment.

Based on the above description of the disclosed embodiments, those skilled in the art are capable of carrying out or using the present application. It is obvious for those skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A connecting structure of an electrical device, comprising a positive input terminal, a positive output terminal, a negative input terminal, and a negative output terminal, wherein
the positive input terminal, the positive output terminal, the negative input terminal, and the negative output terminal each comprises a plug connection portion; and
the plug connection portion of the positive input terminal is different from the plug connection portion of the positive output terminal, and/or, the plug connection portion of the negative input terminal is different from the plug connection portion of the negative output terminal.

2. The connecting structure of the electrical device according to claim 1, wherein the plug connection portion of the positive input terminal is different from the plug connection portion of the negative input terminal, and/or, the plug connection portion of the positive output terminal is different from the plug connection portion of the negative output terminal.

3. The connecting structure of the electrical device according to claim 1, wherein the difference between the plug connection portions comprises a difference in shapes between the plug connection portions and/or a difference in sizes between the plug connection portions.

4. The connecting structure of the electrical device according to claim 1, wherein
the positive input terminal, the positive output terminal, the negative input terminal, and the negative output terminal each comprises a connecting portion configured for connecting a wire with the plug connection portion; wherein
the connecting portion of the positive input terminal is different from the connecting portion of the positive output terminal, and/or, the connecting portion of the negative input terminal is different from the connecting portion of the negative output terminal.

5. The connecting structure of the electrical device according to claim 4, wherein the connecting portion of the positive input terminal is different from the connecting portion of the negative input terminal, and/or, the connecting portion of the positive output terminal is different from the connecting portion of the negative output terminal.

6. The connecting structure of the electrical device according to claim 4, wherein the difference between the connecting portions comprises a difference in shapes between the connecting portions and/or a difference in sizes between the connecting portions.

7. The connecting structure of the electrical device according to claim 1, comprising:
a positive input wire configured to connect a housing of the electrical device with the positive input terminal,
a positive output wire configured to connect the housing with the positive output terminal,
a negative input wire configured to connect the housing with the negative input terminal, and
a negative output wire configured to connect the housing and the negative output terminal, wherein
the positive input wire is different from the positive output wire, and/or, the negative input wire is different from the negative output wire.

8. The connecting structure of the electrical device according to claim 7, wherein the positive input wire is different from the negative input wire, and/or, the positive output wire is different from the negative output wire.

9. The connecting structure of the electrical device according to claim 7, wherein the positive input wire, the positive output wire, the negative input wire, and the negative output wire are wires, and the difference between the wires comprises a difference in lengths between the wires, and/or a difference in colors between the wires, and/or a difference in outer diameters between the wires.

10. The connecting structure of the electrical device according to claim 1, wherein the negative input terminal and the negative output terminal are both female plugs, and the positive input terminal and the positive output terminal are both male plugs.

11. The connecting structure of the electrical device according to claim 1, wherein the number of the positive input terminal and the number of the negative input terminal are both one.

12. The connecting structure of the electrical device according to claim 1, wherein the number of the positive input terminal and the number of the negative input terminal are both at least two, and the positive input terminals are in one-to-one correspondence with the negative input terminals.

13. The connecting structure of the electrical device according to claim 12,
wherein the plug connection portions of any two of the positive input terminals are the same, and/or,
the plug connection portions of any two of the negative input terminals are the same.

14. The connecting structure of the electrical device according to claim 1, wherein
the positive output terminal of the electrical device is configured to be connected to a negative output terminal of another electrical device by insertion.

15. An electrical device, comprising the connecting structure of the electrical device according to claim 1.

16. An electrical device, comprising the connecting structure of the electrical device according to claim 2.

17. An electrical device, comprising the connecting structure of the electrical device according to claim 3.

18. An electrical device, comprising the connecting structure of the electrical device according to claim 4.

19. An electrical device, comprising the connecting structure of the electrical device according to claim 7.

20. An electrical device, comprising the connecting structure of the electrical device according to claim 10.
